(19) United States
(12) Patent Application Publication
(10) Pub. No.: US 2004/0020244 A1
(43) Pub. Date: Feb. 5, 2004

(54) Method and device for forming recesses in a plane sheet of glass as well as a plane sheet of glass comprising recesses

(76) Inventors: Carl Kramer, Aachen (DE); Thomas Kramer, Aachen (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 09/897,710

(22) Filed: Jul. 2, 2001

(30) Foreign Application Priority Data
Jun. 15, 2000 (DE) 101 28 667.8

(51) Int. Cl. C03B 23/035

(52) U.S. Cl. 65/106; 65/67; 65/273; 65/287

(57) ABSTRACT

The invention involves providing a plane sheet of glass with recesses by bringing an initially plane sheet of glass, heated to a temperature sufficient for transformation and in partial areas in contact on one side with a negative mould, into engagement on one side with at least one mould cavity of the negative mould whose dimensions correspond to the desired sheet deformation by means of a pressure differential acting upon the sheet, generated by applying a low pressure or partial vacuum and/or gaseous pressure media, such that the respective deformed area/recess of the sheet is surrounded by non-deformed partial areas of the sheet.

A device for performing said method is also provided.

Such a plane sheet of glass with recesses may be used for receiving a getter tablet and/or for encapsulating an organic LED for the manufacture of a display.

The invention relates to a method and a device for forming recesses in a plane sheet of glass as well as a plane sheet of glass comprising recesses, in particular for the manufacture of organic LEDs for displays.

A number of methods are already known in the prior art for three-dimensionally deforming sheet glass. Accordingly, convex shapes are, for example, achieved by blowing or pressing, with glass tears serving as the starting material. If deformation proceeds from an initially plane sheet of glass, the sinking technique is used, whereby the sheet, mostly held at its edges, is heated to its softening temperature and sinks due to the effect of gravity onto the mould situated beneath. Where high optical demands are to be made on the sheet after deformation, it is laid on a moulding ring and freely sags. This process, called gravity bending, is used for example in the manufacture of spatially warped windscreens for automobiles. In order to accelerate the deformation process, one can always push the sheet held on the moulding ring from beneath against a moulding pad situated above the sheet, and by this partial pressing process accelerate deformation and increase the productivity of the plant.

However, all these methods fail if a number of pocket-like recesses have to be simultaneously formed in one deformation step from a plane sheet of glass as the starting material, and if these pocket-like recesses are to have narrow dimensional tolerances. Such pocket-like recesses in a plane sheet of glass, similar to a tablet blister, are necessary for example in the manufacture of displays based on organic LEDs, in order to accommodate getter tablets in the recesses. The deformed partial portion of the sheet of glass with a getter tablet is connected by adhesive on the edges to the supporting base, likewise made from a sheet of glass, of an organic LED. The getter tablet protects the organic LED by absorbing oxygen and moisture. Given a sheet size of approx. 500×500 mm as the starting material, 100 or more such pockets may be formed according to the size of the LED, which must be aligned most exactly with the corresponding LEDs arranged with regular spacing on a second sheet, such that once the two sheets of glass are stuck together, each organic LED is allocated a getter tablet in a corresponding recess.

There are also, however, yet other applications for a plane sheet of glass with a number of pocket-like recesses, such as for example presentation elements for nesting goods, such as for example pieces of jewellery, or as a unusual lamp, if for example variously coloured light sources are arranged in the pocket-like recesses, or for filling the recesses with gases.

The invention is based on the object of providing a method and a device for forming a multitude of pocket-like recesses in a plane sheet of glass, with narrow dimensional tolerances.

This object is solved by the features of claim 1, as regards the method for forming recesses, and by the features of claim 9, as regards the corresponding device.

In accordance with a further aspect, a plane sheet of glass with pocket-like recesses is to be provided which may in particular be used for the manufacture of encapsulated, protected LEDs for displays, for example for mobile phones.

This is achieved by the features of claim 18.

In the method in accordance with the invention, a sheet of glass which has been heated sufficiently beyond the transformation temperature and which initially sits with one side against a negative mould is brought into engagement with pocket-like cavities, worked out of the negative mould, by the effect of a pressure differential upon the sheet, such that after completion of said process, at least one pocket-like cavity is formed into the sheet, each being surrounded by an area in which the sheet retains its plane starting shape. In this process, the sheet can either sit plane on the negative mould and be deformed by a low pressure or partial vacuum acting in the recesses of the negative mould, or even be pressed into the cavities in the negative mould by a pressure load acting on the side of the sheet facing away from the mould. Furthermore, it is possible to arrange the negative mould above a sheet lying on a base, e.g. a plane surface, lightly press the sheet against the negative mould situated above the sheet, mechanically or with the aid of a gas cushion, and then to deform the sheet using a low pressure or partial vacuum acting on the upper surface of the recesses inside the cavities of the negative mould.

After the deformation process, the sheet advantageously remains in contact with the mould for a certain period of time. During this period of time, the sheet cools downs. As soon as the sheet has again reached the required stiffness by approaching or, as appropriate, dropping below the transformation temperature, the deformed sheet is gently cooled down further. During this gentle, further cooling down, care must be taken that only low rates of cooling occur and that no tension or stress is able to build up in the sheet of glass as a result of cooling.

The invention will now be explained by way of example embodiments and by referring to the enclosed schematic drawings, in which:

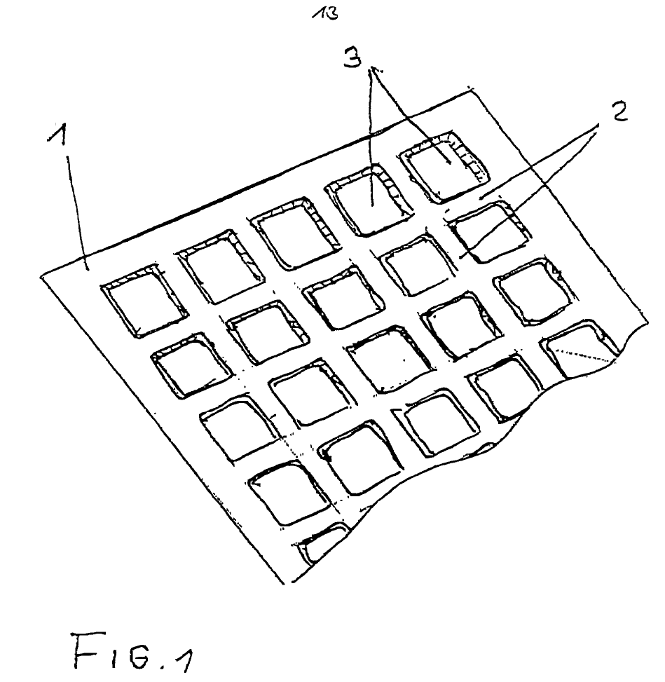

FIG. 1 is a schematic sketch of a deformed sheet of glass with regularly arranged, pocket-like recesses;

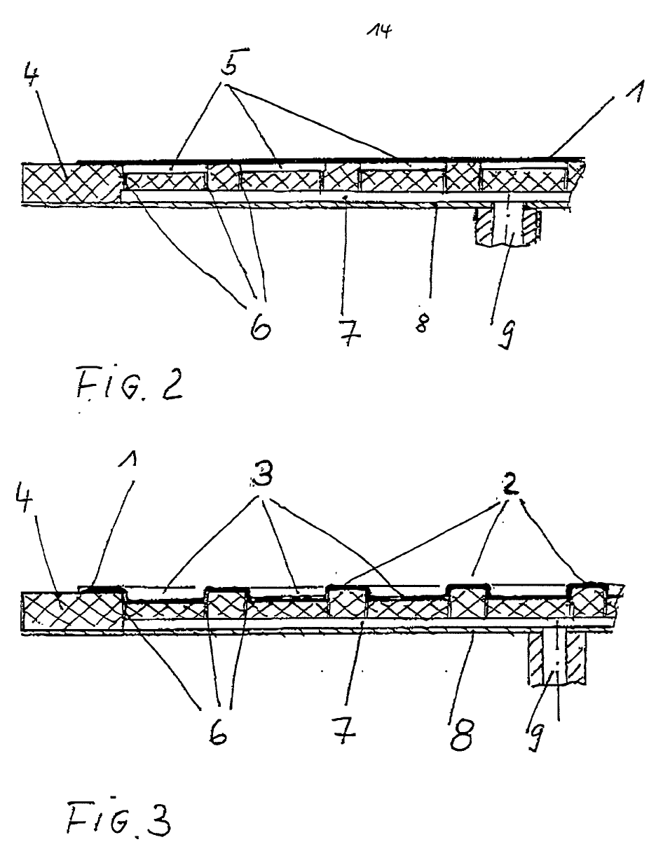

FIG. 2 is the cross-section through a still plane sheet of glass lying on a negative mould;

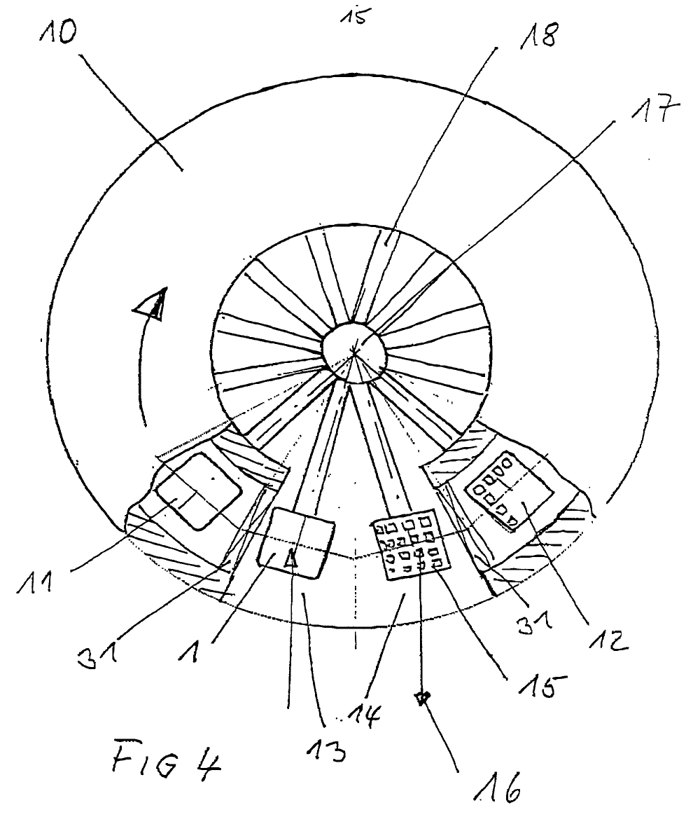

FIG. 3 is the same situation as in FIG. 2, but with an already deformed sheet of glass, lying on a negative mould;

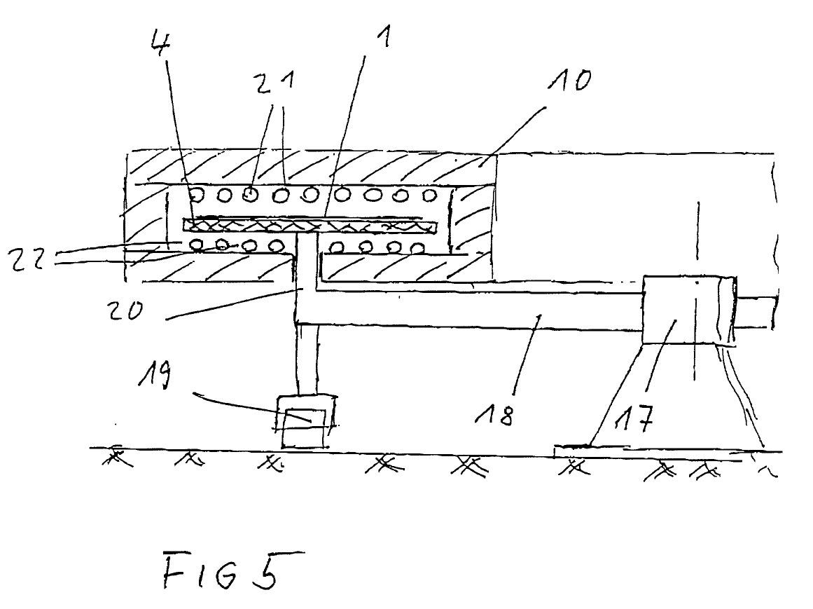

FIG. 4 is a sketch form of the possible embodiment of a production unit, wherein the negative moulds are arranged on a wheel in the manner of a rotary machine, and the wheel is turned so that the sheet to be deformed passes through the various process positions in turn;

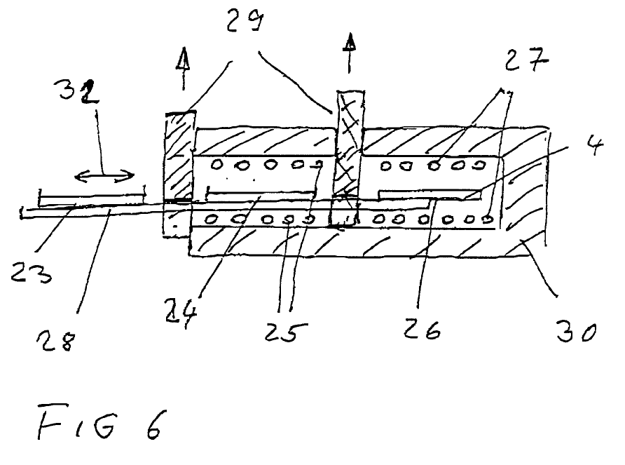

FIG. 5 is a cross-section through a position in which heating and cooling elements are respectively arranged above and below the negative mould and sheet lying on it;

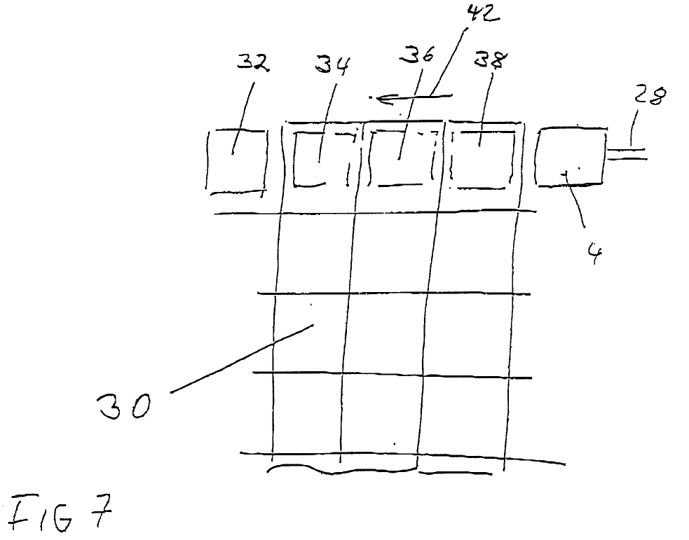

FIG. 6 is a device consisting of two stations, namely a heating station and a cooling station, in which the negative mould and sheet lying on it move in a translatory manner;

FIG. 7 is a possible arrangement of devices such as shown in FIG. 6, alongside one another, wherein plane sheets of glass are automatically loaded, and already deformed sheets of glass are removed, with the aid of suitable lifting apparatus as set forth in the prior art, and with the aid of conventional conveyor belts.

As shown in FIG. 1, once deformation has been completed, the originally plane sheet of glass 1 has a multitude of regularly arranged, pocket-like cavities 3 separated by non-deformed areas 2. Getter tablets are arranged in the pocket-like cavities 3, and the sheet of glass 1 is then adhered or stuck to a second sheet of glass (not shown) which carries an organic LED in each of the areas which correspond to the pocket-like cavities 3 with the getter tablets. The two stuck-together sheets of glass are then cut into pieces, such that individual displays based on organic LEDs are produced, such as may be used, for example, in mobile phones.

Deformation is achieved with the aid of a negative mould 4, in which cavities 5 corresponding to the pockets to be formed are worked into its shape, see FIG. 2. These cavities 5 are advantageously connected to each other by passages 6 formed at the edge of the cavities 5 via a channel 7, to which a low pressure or partial vacuum conduit 9 is attached. The channel 7 may be formed, for example, by millings on the underside of the negative mould 4, which are covered by a covering plate 8.

The surface of the negative mould 4, and in particular of the cavities 5, facing the sheet 1 is coated with a separating or releasing agent, in order to prevent the sheet 1 sticking to the mould 4.

The non-deformed, initially still plane sheet of glass 1 is heated and, once it has reached the deformation temperature, is sucked onto the negative mould 4 and into the cavities 5 by the low pressure or partial vacuum introduced into the cavities 5 by means of the low pressure or partial vacuum conduit 9, the channel 7 and the passages 6, in such a way that the pocket-like recesses 3 are formed in the otherwise plane sheet of glass 1, see FIG. 3. These pocket-like recesses 3 are surrounded by non-deformed areas 2 and separated from each other by them.

Once deformation is complete, it is expedient to leave the sheet 1 with the pocket-shaped recesses 3 in the negative mould 4 for a certain period of time, and so cool it down. For this overall operation of the method, from heating up to cooling down, a device similar to a rotary machine, as shown in FIGS. 4 and 5, is expediently used.

The negative moulds 4, see FIG. 5, are held by support pipes 20 which stand on the spokes 18 of an expediently horizontal wheel with a vertical axis. The spokes 18 are supported against the mounting surface of the device by means of a supporting device 19. The moulds 4 themselves are situated in an isolated housing 10 shaped like a ring channel. Heating and cooling elements 21 and 22 are respectively arranged above and below the moulds 4, upon each of which a sheet of glass 1 lies. The low pressure or partial vacuum conduit is guided through the supporting pipe 20 supporting each negative mould 4, into the corresponding spoke 18 and thence into the hub body 17.

The turning of the wheel is driven, and the low pressure or partial vacuum is supplied, by means of a rotary transformer as set forth in the prior art. Details in this respect are not shown in the figures.

[symbol]

Although a non-contact jet seal is particularly expedient, other, mechanical seals may in principle also be used.

For each phase, corresponding to the rotating of the wheel by one further spoke 18, the sheet 1 in the device proceeds by one position, and is initially heated. Electric heating elements 21 arranged above and below the mould 4 perform the heating. Once the deformation temperature has been reached, the sheet 1 is brought into engagement with the negative mould 4 by introducing a low pressure or partial vacuum. The sheet 1 is subsequently cooled down following a further rotation into the cooling position 12. This is achieved initially with cooling elements 22 which effect a gentle cooling down via radiation exchange with the mould 4 and the sheet 1. The cooling elements 22 can consist, for example, of pipes through which a suitable cooling fluid flows.

After sufficient cooling, the mould 4 together with the already deformed sheet 1 passes through another jet seal 31 and then reaches the removal position 15. From here, the sheet 1 is taken approximately in the direction of the arrow 16 to a cooling oven corresponding to the prior art, and there further cooled down to the desired temperature.

Instead of running rotationally, the method may also be performed by a device in which the moulds 4 only move in a straight line, in one direction. A particularly basic device is shown in FIG. 6. It comprises the loading position 23, a pre-heating and cooling-down position 24 in which cooling elements 25 are arranged both above and below the mould, as well as the heating and deformation position 26 which in turn has heating elements 27 arranged above and below the mould.

The pre-heating and cooling-down position 24 accommodated in an isolated housing 30, as well as the heating and deformation position 26, are separated off from each other and from their surroundings by slides 29. The mould 4 is transported by a connecting rod 28, which also introduces the low pressure or partial vacuum into the negative mould 4.

As may easily be seen, when the slides 29 are operated in working cycle, the mould 4 is moved by means of the connecting rod 28 from the loading station 23, via the station 24 then performing a pre-heating function only, to the heating and deformation station 26, and then back again via the station 24 then performing a cooling function only, to the loading station, where the sheet 1 with the pocket-shaped recesses is removed.

A variant of the working principle of the basic linear conveying device in accordance with FIG. 6 is shown in FIG. 7. This variant is particularly suitable for larger scale manufacture, wherein a number of linear conveying devices in accordance with FIG. 6, but which only work in one direction, are arranged in parallel alongside one another.

The sheet 1 is laid on the mould 4 in the loading position 32, then proceeds to the pre-heating position 34, to the heating-up and deformation position 36 and finally to the cooling position 38. By moving further in the direction of the movement arrow 42, the sheet 1 is discharged from the device on the side opposite the loading position 32, removed and—if necessary—placed in a cooling oven to be cooled to the desired temperature.

Alongside the devices shown in sketch form, wherein the sheet is deformed by a low pressure or partial vacuum, deformation is also possible using a pressure load acting upon the sheet 1 from above, applied by a caisson placed on the sheet 1. Moreover, the sheet 1 can also be raised against a negative mould 4 and then deformed using a low pressure or partial vacuum or a pressure load. Deformation by a pressure differential, generated by a low pressure or partial vacuum and/or by applying gaseous media, acting upon the sheet 1 in the area to be deformed is fundamental to the method in accordance with the invention and for the devices used in accordance with the invention to perform said method.

1. A method for forming at least one recess (3) in a sheet of glass (1) heated to a temperature sufficiently beyond transformation, characterised in that said initially plane sheet of glass (1) which in partial areas is on one side in contact with a negative mould (4) is brought into engagement on one side with at least one mould cavity (5) of said negative mould (4) whose dimensions correspond to the desired sheet deformation by means of a pressure differential, generated by applying a low pressure or partial vacuum and/or gaseous pressure media, acting upon said sheet (1), such that each deformed area (recess 3) of said sheet (1) is surrounded by non-deformed partial areas (2) of said sheet (1).

2. The method as set forth in claim 1, characterised in that a multitude of deformation areas (3) are distributed over the surface of said sheet.

3. The method as set forth in at least one of claims 1 or 2, characterised in that the pressure differential is effected by a low pressure or partial vacuum introduced through the/each mould cavity (5) of the negative mould (4).

4. The method as set forth in at least one of claims 1 to 3, characterised in that, once deformed, said sheet (1) remains in said mould (4) and is cooled to at least the vicinity of said transformation temperature.

5. The method as set forth in at least one of claims 1 to 4, characterised in that, once removed from said mould (4), said sheet (1) with said recesses (3) is further cooled in a cooling oven, at a low rate of cooling to avoid tension or stress.

6. The method as set forth in at least one of claims 1 to 5, characterised in that said sheet (1) is pre-heated to about said mould temperature before it is laid on said mould (4).

7. The method as set forth in at least one of claims 1 to 6, characterised in that said mould (4) is treated and/or coated with a separating or releasing agent to prevent said sheet (1) sticking to the moulding surface.

8. The method as set forth in at least one of claims 1 to 7, characterised in that said sheet (1) is heated, deformed and cooled completely or partially in a non-oxidising protective gas.

9. A device for forming recesses (3) in a sheet of glass (1), characterised by:
a) a heating and deformation station (11; 26; 36) for deforming a plane sheet of glass (1) lying on a negative mould (4) comprising cavities (5) corresponding to said recesses (3) by using a pressure differential acting on both sides of said sheet (1), generated by applying a low pressure or partial vacuum and/or a gaseous pressure medium to said sheet (1);
b) a cooling station (12; 24; 38) for said partially deformed sheet of glass (1); and
c) a conveying device for moving said sheet of glass (1) from station to station.

10. The device as set forth in claim 9, characterised in that said stations are arranged sequentially on a circular arc.

11. The device as set forth in claim 9, characterised in that said stations are arranged on a straight line track.

12. The device as set forth in at least one of claims 9 to 11, characterised by a pre-heating station (24; 34) disposed upstream of said heating and deformation station (11; 26; 36).

13. The device as set forth in at least one of claims 9 to 12, characterised in that pre-heating and/or heating-up and/or deformation and/or cooling take place completely or partially in a protective gas atmosphere.

14. The device as set forth in claim 13, characterised in that a protective gas seal (31) is provided for separating the individual stations from each other.

15. The device as set forth in claim 14, characterised in that an aerodynamic dual jet seal (31) is provided between the individual stations.

16. The device as set forth in at least one of claims 9 to 15, characterised in that a pressure differential bringing a sheet (1) into engagement with said negative mould (4) is also in effect during pre-heating, heating-up and cooling.

17. The device as set forth in at least one of claims 9 to 16, characterised in that said negative mould (4) is made of graphite.

18. A plane sheet of glass (1) with at least one recess (3) produced by the method as set forth in at least one of claims 1 to 9.

19. The plane sheet of glass (1) with at least one recess (3) as set forth in claim 18, for receiving a getter tablet and/or for encapsulating an organic LED in the manufacture of displays.
